(19) United States
(12) Patent Application Publication
(10) Pub. No.: US 2011/0147016 A1
(43) Pub. Date: Jun. 23, 2011

(54) Fluid Selective Check Valve

(75) Inventors: Kevin J. Blease, Easton, PA (US); Joseph K. Banis, Palmer Township, PA (US); William J. Reilly, Langhorne, PA (US)

(73) Assignee: Victaulic Company, Easton, PA (US)

(21) Appl. No.: 12/640,518

(22) Filed: Dec. 17, 2009

(51) Int. Cl. A62C 35/68; F16K 15/04; A62C 35/62

(52) U.S. Cl. 169/17; 137/517; 137/539; 169/20; 169/91

(57) ABSTRACT

A valve has a valve body that defines a chamber. The chamber has an inlet and an outlet through which a flow path passes. A seat is positioned within the chamber and surrounds the flow path. A closing member is positioned within the chamber and a biasing member biases the closing member into an open position away from the seat. The biasing member exerts a biasing force on the closing member which exceeds the force exerted on the closing member by a first fluid which enters the inlet and flows past the closing member and through the open valve. The biasing force is less than the force exerted by a second fluid having one or more different characteristics from the first fluid. Force exerted by the second fluid on the closing member overcomes the biasing force and moves the closing member into engagement with the seat, closing the valve.

### FIELD OF THE INVENTION

This invention relates to check valves, and especially to check valves which selectively permit or prevent fluid flow based upon the characteristics of the fluid.

### BACKGROUND

Check valves find extensive use throughout many technologies where control of fluid flow is necessary. Check valves are used when it is desired to block the flow of fluid in one direction through a conduit or pipeline but allow the flow in the opposite direction. Check valves perform this function autonomously, that is, without active or external control, and are simple, inexpensive and reliable. However, due to their simplicity, check valves are limited in their function to indiscriminately block fluid flow by virtue only of its flow direction. There are situations, however, where it is desirable to block fluid flow in a particular direction or allow fluid flow in that same direction based upon criteria other than the mere direction of fluid flow. Criteria for blocking or permitting the flow of fluid other than the direction of flow may include, for example, the type of fluid, the phase of the fluid, the fluid viscosity, pressure, or rate of flow. For example, it may be desired to allow the flow of air through a conduit, but block the flow of water through the conduit. Such a situation occurs, for example, in negative pressure fire suppression sprinkler systems.

Fire suppression sprinkler systems for protection of structures such as office buildings, warehouses, hotels, schools and the like are required when there is a significant amount of combustible matter present. The combustible matter may be found in the materials from which the structure itself is constructed, as well as in its contents, such as furnishings or stored goods. Fire suppression sprinkler systems typically include a piping network that extends throughout the structure, the piping network being connected to a source of pressurized water and having many sprinklers distributed throughout the structure. The sprinklers open in the event of a fire and discharge the water to suppress the spread of and to extinguish the fire.

Of the various types of sprinkler systems available, the “dry pipe” system finds widespread use. In dry pipe systems water is absent from the piping network until a fire is detected. Dry pipe systems use an actuator to trip a valve which provides water to the sprinkler piping network during a fire. The actuator responds to a signal or combination of signals indicative of a fire from one or more detectors. Dry pipe systems are of two main types, the positive pressure type, wherein the piping network is normally filled with compressed air (and not water) prior to actuation, and the negative pressure type, in which the piping network is filled with air at a pressure lower than atmospheric pressure. The absence of water within the piping network allows dry pipe systems to be used in unheated environments which are subject to below freezing temperatures without fear of pipes bursting due to water within the pipes expanding upon freezing.

The negative pressure dry pipe system uses a vacuum pump connected with the piping network to establish and maintain negative air pressure within the piping network. Once a sufficient vacuum is drawn, the behavior of the air within the piping network of a negative pressure dry pipe system may be used to indicate a fire condition and trigger actuation of the system. Heat from the fire will cause sprinklers to open, allowing ambient air to enter the piping network through the open sprinklers which results in a pressure increase within the piping network. Actuation of the system may be effectively triggered by this pressure increase through the use of a negative pressure actuator as described in U.S. patent application Ser. No. 12/050,375, hereby incorporated by reference. Upon actuation, the valve controlling the flow of water to the piping network is opened, allowing water to flood into the piping network and be discharged through the open sprinklers.

After actuation of the system it is desired to prevent water from reaching the vacuum pump, where it could cause damage. This can be accomplished using a shut-off valve. However, such a valve must be actively controlled so that it remains open while the system is quiescent to permit the vacuum pump to establish and maintain negative air pressure within the system, and closed upon system activation to prevent water from reaching the vacuum pump. Clearly, it would be advantageous to use a valve which would operate autonomously (without active control) to protect the vacuum pump by remaining open when air is in the piping network but closing to prevent water from reaching the vacuum pump.

### SUMMARY

The invention concerns a valve comprising a body having an inlet, an outlet, and defining a chamber positioned in a flow path between the inlet and the outlet. The chamber provides fluid communication between the inlet and the outlet. A seat is positioned within the chamber. A closing member is positioned within the chamber. The closing member is movable between an open position, in spaced apart relation away from the seat, and a closed position, sealingly engaged with the seat. A biasing member is positioned within the chamber. The biasing member is engaged with and biases the closing member into the open position.

In one embodiment, the biasing member biases the closing member toward the inlet. The biasing member may be positioned between the outlet and the closing member. The closing member may comprise a ball and the biasing member may comprise a spring positioned between the outlet and the ball. In this embodiment the seat may be positioned between the ball and the spring.

In certain embodiments an adjustable support is positioned within the chamber between the spring and the outlet. The adjustable support engages the spring and is adjustably movable toward and away from the ball to vary compression on the spring. To facilitate adjustment the adjustable support comprises a ring which is threadedly engaged with the body.

In an alternate embodiment the closing member may comprise a vane pivotably mounted within the chamber. The biasing member may comprise a spring mounted within the chamber and adapted to apply a torque to the vane to bias the vane into the open position. The vane has a surface sealingly engageable with the seat when in the closed position.

An alternate embodiment of the valve according to the invention comprises a body defining a chamber. The chamber has an inlet in fluid communication with the chamber. An outlet is also in fluid communication with the chamber, and the inlet, the outlet and the chamber are coaxially aligned with one another in this embodiment. A seat is positioned within the chamber and surrounds a fluid flow path through the chamber. A closing member is positioned within the chamber. The closing member is movable between an open position in spaced apart relation away from the seat, and a closed position sealingly engaged with the seat. A biasing member is positioned within the chamber. The biasing member is engaged with and biases the closing member into the open position.

The invention also encompasses a fire suppression sprinkler system comprising a piping network in fluid communication with a source of pressurized liquid. A plurality of sprinklers is in fluid communication with the piping network. A first valve is positioned within the piping network between the source of pressurized liquid and the sprinklers. The first valve controls the flow of the liquid to the sprinklers. A vacuum pump is in fluid communication with the piping network for removing a gas from the piping network. A second valve, having an inlet in fluid communication with the piping network and an outlet in fluid communication with the vacuum pump, permits flow of the gas to the vacuum pump but prevents flow of the liquid thereto. The second valve further comprises a body defining a chamber positioned in a flow path between the inlet and the outlet. The chamber provides fluid communication between the inlet and the outlet. A seat is positioned within the chamber. A closing member is positioned within the chamber. The closing member is movable between an open position in spaced apart relation away from the seat for permitting flow of the gas, and a closed position sealingly engaged with the seat for preventing flow of the liquid. A biasing member is positioned within the chamber. The biasing member is engaged with and biases the closing member into the open position.

The invention further includes a method of selectively permitting flow of a first fluid and preventing flow of a second fluid. The second fluid has at least one characteristic, for example, the type of fluid, its rate of flow, its viscosity, its density, its pressure or its phase different from the first fluid. The method comprises:
(a) using a valve having a closing member and a biasing member biasing the closing member with a biasing force;
(b) biasing the closing member into an open position with the biasing force being greater than a first force applied to the closing member by the flow of the first fluid past the closing member, the biasing force being less than a second force applied to the closing member by the flow of the second fluid past the closing member.

### BRIEF DESCRIPTION OF THE DRAWINGS

FIG. 1 is a longitudinal sectional view of an example valve according to the invention shown in an open configuration;

FIG. 2 is a longitudinal sectional view of the valve shown in FIG. 1 but in a closed configuration;

FIG. 3 is a cross sectional view taken at line 3-3 of FIG. 1;

FIG. 4 is a cross sectional view taken at line 4-4 of FIG. 1;

FIG. 5 is a longitudinal sectional view of another example embodiment of a valve according to the invention shown in an open configuration;

FIG. 6 is a longitudinal sectional view of the valve shown in FIG. 5 but in a closed configuration; and

FIG. 7 is a schematic view of a fire suppression sprinkler system using a valve according to the invention.

### DETAILED DESCRIPTION

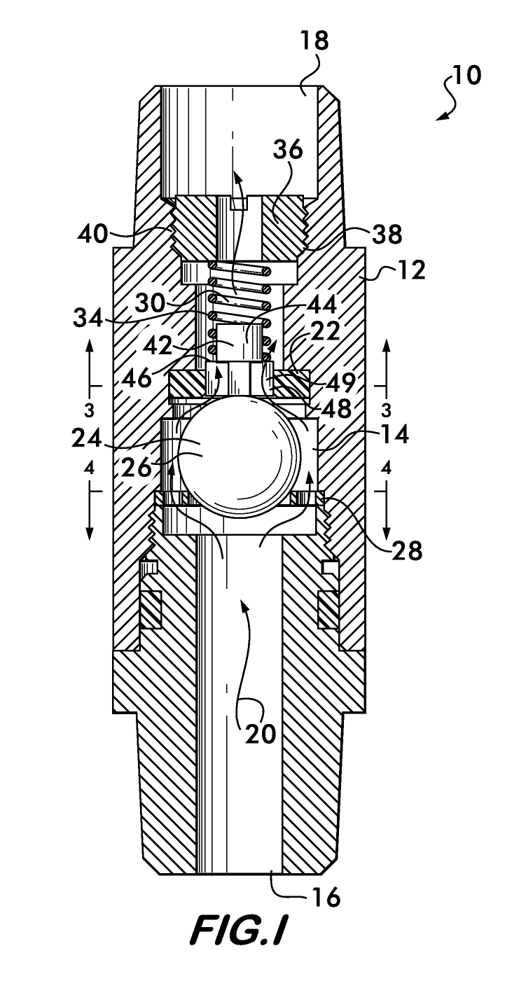

FIG. 1 shows a longitudinal sectional view of a valve 10 according to the invention. Valve 10 has a body 12 which defines a chamber 14. The body 12 has an inlet 16 and an outlet 18, both in fluid communication with the chamber 14. The chamber 14 is positioned within a flow path 20 between the inlet 16 and the outlet 18. In this example embodiment the inlet, outlet and chamber are substantially coaxially aligned with one another thereby providing a substantially linear flow path 20 through the valve 10.

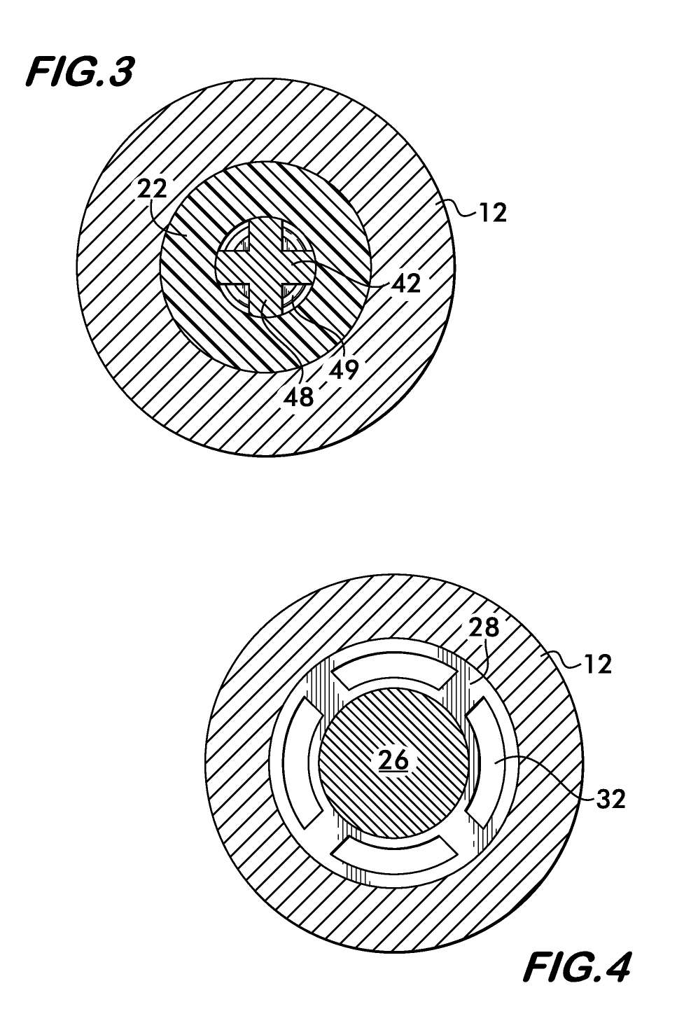

A seat 22 is positioned within the chamber 14 of body 12. The seat surrounds the flow path 20 and may be made of an elastic material, such as EPDM, nitrite and fluroelastomers. Seat 22 cooperates with a valve closing member 24 to form a fluid tight seal and prevent flow of fluid through the chamber when the seat is engaged by the valve closing member. In the example embodiment shown in FIG. 1, the closing member comprises a ball 26 captured within the chamber 14 between a support spider 28 and a biasing member 30. As shown in FIG. 4, support spider 28 has openings 32 which permit fluid to flow through the chamber 14 and around the ball 26. In this example, as shown in FIG. 1, the biasing member comprises a coil spring 34 positioned between the outlet 18 and the ball 26. The coil spring is supported at one end by a ring 36 positioned within the chamber 14. The ring 36 has external threads 38 which engage compatible internal threads 40 within the body 12. The threaded engagement between ring 36 and body 12 allow the ring to move toward and away from ball 26 upon rotation of the ring relatively to the body 12 and thereby provide an adjustable support to the spring. The adjustability of ring 36 permits the biasing force on the ball 26 to be set as necessary to ensure proper valve operation as described below. Note that the ball 26 is biased by spring 34 into an open position away from the seat 22 and toward the inlet 16. In the embodiment shown in FIG. 1, the opposite end of spring 34 does not engage the ball 26 directly, but uses an intermediate guide piece 42. Guide piece 42 has a projection 44 and an annular flat surface 46 at one end to best engage the spring. At the opposite end, as shown in FIG. 3, the guide piece 42 has a cruciform cross section 48 which define a plurality of ducts 49 through which fluid may flow past the guide piece as shown in FIG. 1. Intermediate guide piece 42 ensures positive, reliable action of the ball 26 within the chamber 14 during valve operation.

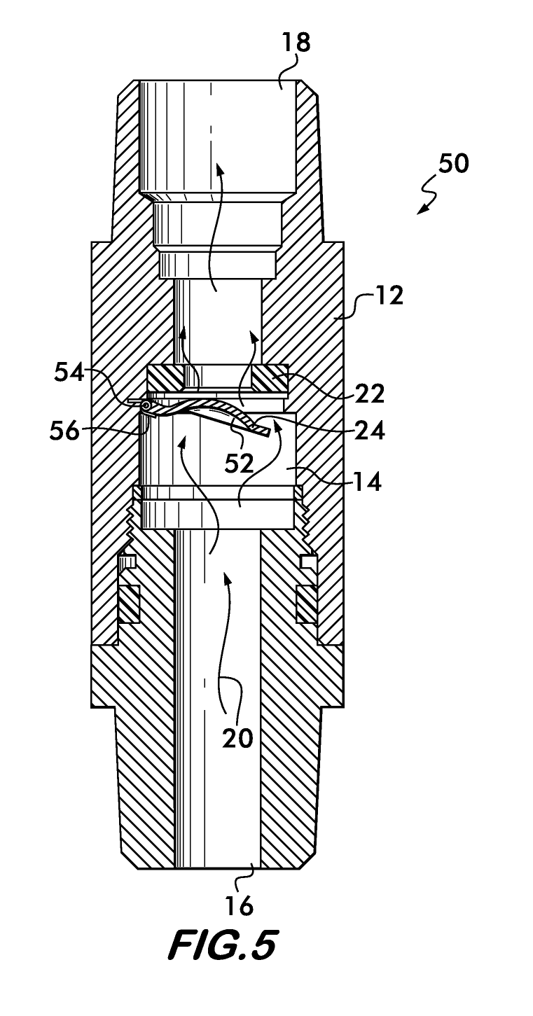

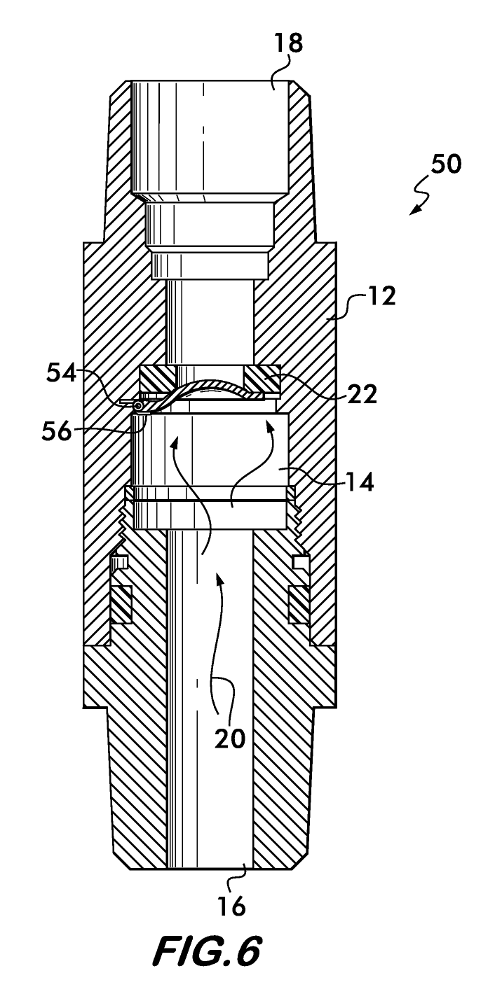

FIG. 5 illustrates another embodiment 50 of the valve according to the invention wherein the valve closing member 24 comprises a vane 52 pivotably mounted within the chamber 14. Vane 52 pivots about an axis of rotation 54 between an open position away from seat 22 (shown in FIG. 5), and a closed position in sealing engagement with the seat as shown in FIG. 6. The vane 52 is biased into the open position by a spring 56 which exerts a torque on the vane about axis 54 to maintain the vane in the open position until sufficient force is exerted on the vane to overcome the biasing torque during valve operation as described below.

The valve embodiments 10 and 50 according to the invention operate autonomously and selectively to permit flow of a first fluid from the inlet 16 through the chamber 14 and to the outlet 18 while preventing flow of a second fluid in the manner of a check valve. Many different characteristics of the fluid may be used to distinguish the first fluid from the second fluid. For example, the fluids may be of different types, i.e., the first fluid may be air and the second fluid may be water. The fluids may be the same, but in different phases, for example, the first fluid may be steam and the second fluid may be liquid water. The fluids may be the same, but flowing at different rates, for example, the first fluid may be air flowing at or below 10 feet per second, and the second fluid may be air flowing above 10 feet per second. Further examples of distinguishing fluid characteristics include fluid density, viscosity and pressure as well as any combination of characteristics.

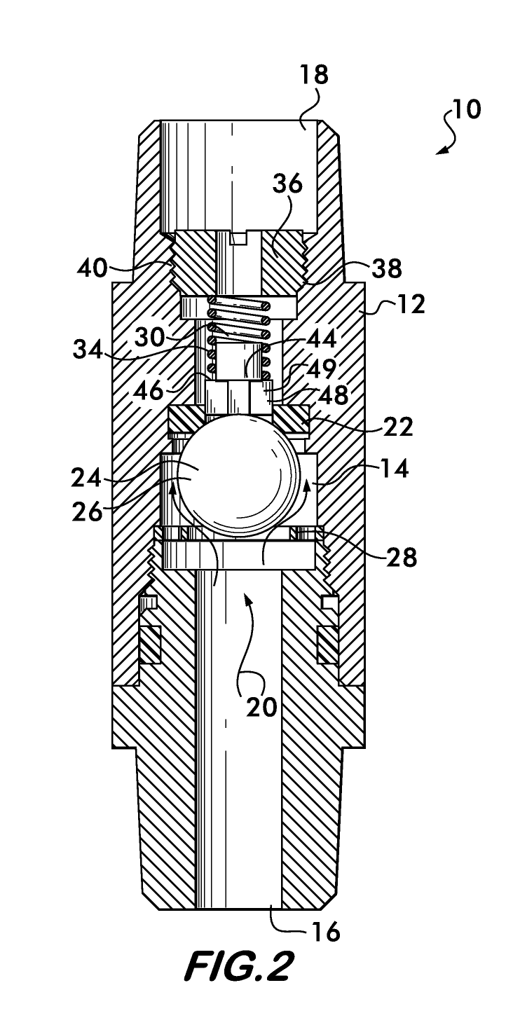

In operation of the valve according to the invention, the biasing member is designed and/or adjusted so that the biasing force which it applies to the closing member is greater than the force exerted on the closing member by the first fluid as it flows through the valve, but less than the force exerted on the closing member by the second fluid as it flows through the valve. For example, if the first fluid is air and the second fluid is water, and the valve embodiment 10 is used, then the spring 34 is designed and adjusted to apply a biasing force to ball 26 which is greater than the drag and pressure forces exerted by the air on ball 26 at an expected air flow rate as it travels through the chamber 14 past the ball. The ball 26 is thus maintained in an open position against the air flow as shown in FIG. 1. However, the biasing force on the ball 26 is also designed and adjusted to be less than the pressure and drag force exerted on the ball by water flowing through the valve at an expected rate of flow. As shown in FIG. 2, water flow through the valve will apply a force on the ball which overcomes the biasing force of spring 34, thereby forcing the ball 26 against the seat 22 and closing the valve 10. It is thought that, due to the large difference in density and viscosity between the gaseous air and the liquid water, there will be a significant difference between the drag and pressure force exerted on the ball 26 by air in comparison with the drag and pressure forces exerted on the ball by the water, such that it will be relatively easy to design and adjust a spring which can differentiate between the two flows.

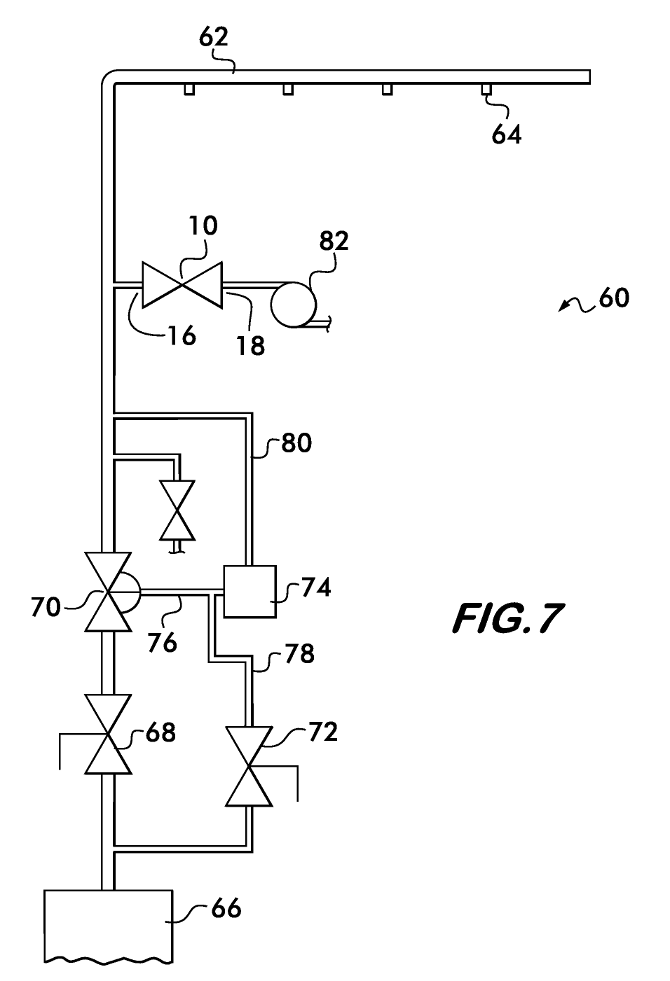

A practical example wherein a valve according to the invention would prove useful is in a negative pressure dry pipe fire suppression sprinkler system as shown at 60 in FIG. 7. System 60 comprises a piping network 62 which extends throughout the structure (not shown), such as a building or warehouse, in which the system is installed. A plurality of sprinklers 64 are mounted on the piping network throughout the structure for the discharge of water or other fire suppressing fluid in the event of a fire. The sprinklers have a heat sensitive element which opens the sprinkler in response to heat generated by a fire. Other triggering methods are also feasible. The piping network 62 is substantially fluid tight when all of the sprinklers 64 are closed.

Piping network 62 is connected to a source of pressurized water 66 or other fire suppressing fluid. In an example system, the source of water 66 may be a municipal water service water main. Water flow from the source 66 to the piping network 62 is controlled by a service valve 68 and a control valve 70. Service valve 68 is used to isolate the piping network 62 from the water source 66 so that the components can be serviced, replaced, repaired or reset after actuation due to a fire or a test. When the system is in operation, the service valve 68 is open, allowing pressurized water to the control valve 70. A trim valve 72 is used to provide fluid communication between the source 66 and the mechanisms of control valve 70 and is used to set and reset the control valve during operation.

Control valve 70 controls the flow of water to the piping network 62. In the negative pressure system 60, the control valve 70 is normally closed and is opened by a negative pressure actuator 74 in response to a fire. Negative pressure actuator 74 is in fluid communication with the control valve 70 through a conduit 76. Both the control valve 70 and the actuator 74 are in fluid communication with pressurized water source 66 through a conduit 78. (Flow of water through conduit 78 is controlled by the aforementioned trim valve 72.) Negative pressure actuator 74 is also in fluid communication with piping network 62 through a conduit 80.

The piping network 62 is maintained at a negative pressure (below atmospheric pressure) by a vacuum pump 82. The vacuum pump is in fluid communication with the piping network through a valve according to the invention such as valve 10. The inlet 16 of valve 10 is connected to the piping network 62 and the outlet 18 is connected to the vacuum pump 82. Valve 10 is normally biased open to allow air to be drawn by the vacuum pump from the piping network 62 as required to establish and maintain the negative pressure condition within the network. The valve 10 must close however, to protect the vacuum pump 82 when water enters the piping network during test or actuation of the system.

In operation of the system 60, the service valve 68 is opened to allow water to the control valve 70, which is closed to prevent water from entering the piping network 62, this being a dry pipe system. The trim valve 72 is used to set the actuator 74 into a ready state. The actuator 74 will trigger the opening of control valve 70 via fluid communication through conduit 76 in the event of a fire as described below. The vacuum pump 82 operates through valve 10 to draw air from the piping network 62 and establish and maintain negative air pressure within the network. Air flow through the valve 10 does not exert sufficient force on the ball 26 (see FIG. 1) to overcome the biasing force of spring 34, and the valve 10 remains open while the vacuum pump 82 is operating.

During a fire, one or more of the sprinklers 64 open and admit ambient air to the piping network 62 at a rate with which the vacuum pump 82 cannot keep pace. The vacuum pump is consequently not able to maintain the network 62 negative pressure, resulting in a pressure increase within the network. This pressure increase is communicated to the negative pressure actuator through conduit 80, which, in response thereto, opens the control valve 70 using its connection through conduit 76. Water from source 66 enters the piping network 62 and is discharged onto the fire through the open sprinkler or sprinklers 64. Water that enters the inlet 16 of valve 10 applies a force to the ball 26 which overcomes the biasing force of spring 34 and forces the ball into engagement with seat 22, thereby closing the valve and preventing water in the piping network from reaching the vacuum pump 82.

Valves according to the invention act autonomously and selectively to pass one or more fluids having certain characteristics while blocking the same fluid or a different fluid or fluids having one or more different characteristics.

What is claimed is:

1. A valve comprising:
a body having an inlet, an outlet, and defining a chamber positioned in a flow path between said inlet and said outlet, said chamber providing fluid communication between said inlet and said outlet;
a seat positioned within said chamber;
a closing member positioned within said chamber, said closing member being movable between an open position in spaced apart relation away from said seat, and a closed position sealingly engaged with said seat;
a biasing member positioned within said chamber, said biasing member being engaged with and biasing said closing member into said open position.

2. The valve according to claim 1, wherein said biasing member biases said closing member toward said inlet.

3. The valve according to claim 2, wherein said biasing member is positioned between said outlet and said closing member.

4. The valve according to claim 1, wherein said closing member comprises a ball and said biasing member comprises a spring positioned between said outlet and said ball.

5. The valve according to claim 4, wherein said seat is positioned between said ball and said spring.

6. The valve according to claim 4, further comprising an adjustable support positioned within said chamber between said spring and said outlet, said adjustable support engaging said spring and being adjustably movable toward and away from said ball to vary compression on said spring.

7. The valve according to claim 6, wherein said adjustable support comprises a ring which is threadedly engaged with said body.

8. The valve according to claim 1, wherein said closing member comprises a vane pivotably mounted within said chamber, and, said biasing member comprises a spring mounted within said chamber and adapted to apply a torque to said vane to bias said vane into said open position, said vane having a surface sealingly engageable with said seat when in said closed position.

9. A valve comprising:
a body defining a chamber;
an inlet in fluid communication with said chamber;
an outlet in fluid communication with said chamber, said inlet, said outlet and said chamber being coaxially aligned with one another,
a seat positioned within said chamber and surrounding a fluid flow path through said chamber;
a closing member positioned within said chamber, said closing member being movable between an open position in spaced apart relation away from said seat, and a closed position sealingly engaged with said seat;
a biasing member positioned within said chamber, said biasing member being engaged with and biasing said closing member into said open position.

10. The valve according to claim 9, wherein said biasing member biases said closing member toward said inlet.

11. The valve according to claim 10, wherein said biasing member is positioned between said outlet and said closing member.

12. The valve according to claim 9, wherein said closing member comprises a ball and said biasing member comprises a spring positioned between said outlet and said ball.

13. The valve according to claim 12, wherein said seat is positioned between said ball and said spring.

14. The valve according to claim 12, further comprising an adjustable support positioned within said chamber between said spring and said outlet, said adjustable support engaging said spring and being adjustably movable toward and away from said ball to vary compression on said spring.

15. The valve according to claim 14, wherein said adjustable support comprises a ring which is threadedly engaged with said body.

16. The valve according to claim 9, wherein said closing member comprises a vane pivotably mounted within said chamber and said biasing member comprises a spring mounted within said chamber and adapted to apply a torque to said vane to bias said vane into said open position, said vane having a surface sealingly engageable with said seat when in said closed position.

17. A fire suppression sprinkler system comprising:
a piping network in fluid communication with a source of pressurized liquid;
a plurality of sprinklers in fluid communication with said piping network;
a first valve positioned within said piping network between said source of pressurized liquid and said sprinklers for controlling flow of said liquid to said sprinklers;
a vacuum pump in fluid communication with said piping network for removing a gas from said piping network;
a second valve having an inlet in fluid communication with said piping network and an outlet in fluid communication with said vacuum pump, said second valve permitting flow of said gas to said vacuum pump and preventing flow of said liquid thereto, said second valve further comprising:
a body defining a chamber positioned in a flow path between said inlet and said outlet, said chamber providing fluid communication between said inlet and said outlet;
a seat positioned within said chamber;
a closing member positioned within said chamber, said closing member being movable between an open position in spaced apart relation away from said seat for permitting flow of said gas, and a closed position sealingly engaged with said seat for preventing flow of said liquid;
a biasing member positioned within said chamber, said biasing member being engaged with and biasing said closing member into said open position.

18. The fire suppression sprinkler system according to claim 17, wherein said biasing member biases said closing member toward said inlet.

19. The fire suppression sprinkler system according to claim 18, wherein said biasing member is positioned between said outlet and said closing member.

20. The fire suppression sprinkler system according to claim 17, wherein said closing member comprises a ball and said biasing member comprises a spring positioned between said outlet and said ball.

21. The fire suppression sprinkler system according to claim 20, wherein said seat is positioned between said ball and said spring.

22. The fire suppression sprinkler system according to claim 20, further comprising an adjustable support positioned within said chamber between said spring and said outlet, said adjustable support engaging said spring and being adjustably movable toward and away from said ball to vary compression on said spring.

23. The fire suppression sprinkler system according to claim 22, wherein said adjustable support comprises a ring which is threadedly engaged with said body.

24. The fire suppression sprinkler system according to claim 17, wherein said closing member comprises a vane pivotably mounted within said chamber and said biasing member comprises a spring adapted to apply a torque to said vane to bias said vane into said open position to permit flow of said gas, said vane having a surface sealingly engageable with said seat when in said closed position for preventing flow of said liquid.

25. A method of selectively permitting flow of a first fluid and preventing flow of a second fluid, said second fluid having at least one characteristic different from said first fluid, said method comprising:
using a valve having a closing member and a biasing member biasing said closing member with a biasing force;
biasing said closing member into an open position with said biasing force being greater than a first force applied to said closing member by said flow of said first fluid past said closing member, said biasing force being less than a second force applied to said closing member by said flow of said second fluid past said closing member.

26. The method according to claim 25, wherein said characteristic is selected from the group consisting of type of fluid, rate of flow, fluid density, fluid viscosity, fluid pressure, fluid phase and combinations thereof.
